(19) United States
(12) Patent Application Publication
(10) Pub. No.: US 2004/0180648 A1
(43) Pub. Date: Sep. 16, 2004

(54) Method and apparatus for constraining services for a communication device

(75) Inventors: James Allen Hymel, Lake Worth, FL (US); Christopher Richard Long, Boca Raton, FL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/385,582

(22) Filed: Mar. 11, 2003

(51) Int. Cl. H04M 3/00

(52) U.S. Cl. 455/418; 455/414.1

(57) ABSTRACT

A communication device 101 and corresponding method 300 provides services for a user where the services are controlled by at least one other communication device 103, the communication device 200 includes a receiver 203 to receive from the other communication device a message including a service constraint 221 on services available for the communication device; and a controller 207 responsive to the message and inputs from the user, to enable operation of the communication device subject to the service constraint.

### FIELD OF THE INVENTION

This invention relates in general to communication systems and services, and more specifically to a method and apparatus for controlling or constraining services available to a communications device.

### BACKGROUND OF THE INVENTION

Communications systems such as two way voice and messaging systems and cellular telephone systems suitable for providing communications services and the corresponding communications or subscriber devices or devices providing data and voice services for operating therein are known. Typically the charges or tariffs for these services are related to the extent the services are used. Normally at the time a communications device is enabled with or deployed on a particular service providers network a service agreement is entered into and the communications device is provisioned or programmed for certain service capabilities. Once these formalities are implemented no further control of the services available to a communications device is provided for, other than a lock feature offered by some manufacturers of such devices where the device is disabled for services other than 911 calls, for example.

Often one entity will be responsible for paying for the services that have been utilized by another entity that is the actual consumer. Situations exemplified by a parent/child or employer/employee relationship are typical cases. Clearly a need exists for methods and apparatus to control or constrain services available to a communications devices or a user of the device, preferably on a quasi real time basis.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts, in a simplified and representative form, a communications system and communications devices suitable for controlling services available to one communications device by another such device;

FIG. 2 depicts a block diagram of a preferred embodiment of a communications device arranged for controlling services at at least one other communications device or for having local services controlled by the other communications device; and

FIG. 3 illustrates a flow chart of a preferred method embodiment of controlling services available to a user of a communications device.

### DETAILED DESCRIPTION OF PREFERRED EMBODIMENTS

In overview, the present disclosure concerns communications systems that provide services such as voice and data communications services to communications devices or units, often referred to as subscriber devices, such as cellular phones or two-way radios and the like operating therein or specifically users of such services. More particularly various inventive concepts and principles embodied in communications devices and methods therein for providing controlled services at at least one communications device where the control is exercised by at least one other communications device are discussed. Note that the communications device exercising control or constraint over the services available to the other communications device can be a variety of devices, such as a personal digital assistant, personal computer, preferably equipped for wireless operation, a cellular handset or device, or equivalents thereof.

The communications systems and communications devices that are of particular interest are those that provide or facilitate voice communications services or data or messaging services, such as conventional two way systems and devices, various cellular phone systems including analog and digital cellular, CDMA (code division multiple access) and variants thereof, GSM, GPRS (General Packet Radio System), 2.5 G and 3G systems such as UMTS (Universal Mobile Telecommunication Service) systems, integrated digital enhanced networks and variants or evolutions thereof. Similarly, the communication systems and devices can include LAN (local area network) systems that employ any one of a number of networking protocols, such as TCP/IP (Transmission Control Protocol/Internet Protocol), AppleTalk™, IPX/SPX (Inter-Packet Exchange/Sequential Packet Exchange), Net BIOS (Network Basic Input Output System) or any other packet structures.

As further discussed below various inventive principles and combinations thereof are advantageously employed to provide a service constraint in a near real time basis for a communications device where the service constraint is adaptable and may be adapted to a particular user of the communications device and that users circumstances, thus alleviating various problems associated with known static or fixed service constraints or profiles while still facilitating a full range of services as deemed appropriate for the communications device provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

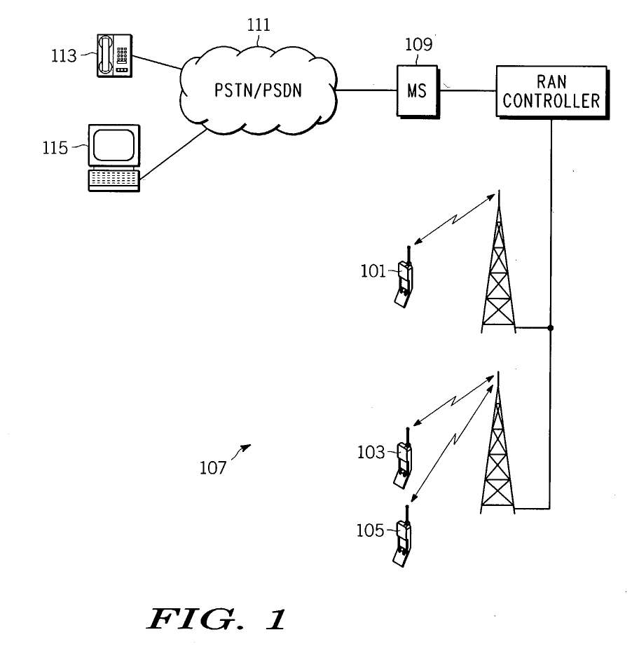

Referring to FIG. 1, a simplified and representative communications system and communications devices suitable for controlling services available to at least one communications device by at least one other communications device will be discussed and described. FIG. 1 shows communications devices 101, 103, 105 or wireless communications units or subscriber devices, such as cellular handsets coupled via radio signals to a radio access network 107, such as a mobile phone or cellular system. The radio access network 107 includes or is coupled to a mobile switch 109 that is further coupled to the PSTN (public switched telephone system or the like) or public switched data network 111, such as the Internet or World Wide Web. These networks serve a multiplicity of wired telephones 113, one depicted, or data platforms 115, such as computers with one depicted. Generally these systems are known to one of ordinary skill and thus not further described.

The communications devices 101, 103, 105 are also generally known other than the modifications and improvements disclosed herein. Thus the known functions and structure of such devices will not be described in detail other than as related to the inventive principles and concepts disclosed and discussed below. Generally one or more of the communications devices is a master communications device and one or more of the communications devices are subordinate to at least one of the master devices. A master communications device can have numerous subordinate devices and for that matter a subordinate device can have multiple masters, although conflicts could arise in this situation and forum shopping can result when a subordinate is requesting permission to utilize services. Furthermore, a given communications device can be subordinate to another master device and also a master device for another subordinate communications device. The master communications devices are arranged to control communications services, including for example the when, what, and how much or type and extent of such services that a subordinate device is given permission or allowed to enjoy, consume, or utilize. Preferably, this control is exercised by communicating a service constraint to the subordinate communications device.

Controlling services can be advantageous, for example, in a parent/child relationship in which the parent is responsible for the charges while the child needs or enjoys the services. For various reasons, such as emergencies and other circumstances that may require assistance or simply establishing expectations as to the child's whereabouts, the parent may want the child to have the cellular phone, while at the same time want to control how much or under what circumstances and how the phone is used. Another example, motivated by factors other than economic ones, may be a parent that treats using the phone as a privilege with the availability or extent of the availability employed by the parent to encourage appropriate behaviors. Similarly, an employer may wish to control or constrain the services that are available to an employee that is provided a communications device, and this control may be strongly circumstance specific.

Various forms of control or a service constraint are envisioned and enabled using the inventive concepts and principles discussed and disclosed. For example, subordinate communications devices or units may be enabled or restricted from dialing particular phone numbers or exchanging text messages with certain addresses. The subordinate phone or communications device can be enabled for or restricted to a certain number of minutes of or amount of airtime or amount of airtime per week or a certain number of messages or characters and so on. The subordinate device can be restricted to only incoming calls or messages or only origination to certain numbers or email addresses.

The master communications device or specifically the user thereof can also arrange service constraints in predefined packages or sets. For example, there can be a set of constraints or a first predefined package that limits use of the subordinate communications device to exchanging calls and messages with the master device and 911 calls and a second set or package that includes a certain amount (15 minutes per week or 30 messages) of discretionary calls or messages to or with discretionary targets or devices, while another package provides additional amounts of services. A Parent can thus have different levels of services for different children or the same child under varying circumstances that are readily communicated to the subordinate device. An employer can thus have a closely controlled package for junior service people and a more generous package for supervisors and so on.

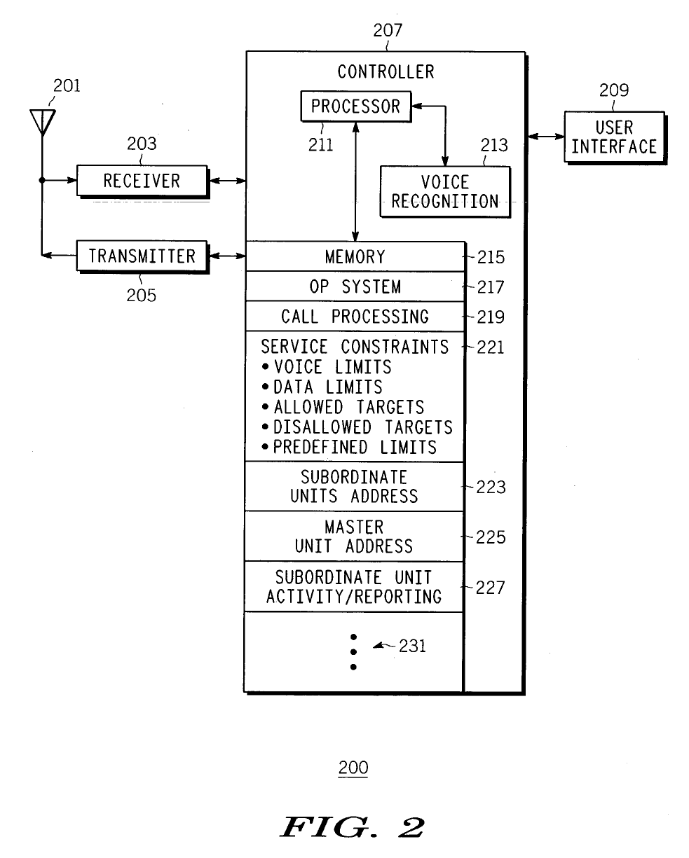

Referring to FIG. 2 a block diagram of a preferred embodiment of a communications device, such as any one of the devices 101, 103, 105, arranged for controlling services at an other communications device or for having local services controlled by the other communications device will be discussed and described. The communications device is arranged and constructed to control services or have services controlled by another communications device, these services provided to or for a user of the controlled or subordinate communications device. Note that the specific functionality of portions, functional blocks or elements of the communications unit or device will depend on the particular access technology and other conventions used by the service provider. These specifics of transmission and reception and relevant processing are known and therefore any further discussions will be in generalities that are applicable to typical communications systems.

The communications device includes an antenna 201 that operates to absorb and radiate radio frequency signals that are received by a receiver 203 or transmitted or sent from a transmitter 205 as is known. The receiver 203 provides a base band signal that is coupled to a controller 207 for further processing, such as call and audio or message processing. The transmitter 205 is also coupled to the controller 207 and the controller 207 operates to generate base band messages and so on, as known, to prepare uplink signals for amplification and transmission by the transmitter 205.

The controller 207 is coupled to a user interface 209 that includes, for example, audio transducers, such as an earpiece or speaker and microphone, display, and keypad. The transmitter 205, receiver 203, and user interface 209 are each inter-coupled, as depicted, to the controller 207 and the controller 207 provides overall operational command and control for the communications device. The controller 207 is coupled to and operates together with the display and keyboard or set of keys to effect a portion of a user interface experience and to facilitate development or selection of service constraints or to request services. The keyboard can be a known physical keyboard or virtual keyboard that is part of the display and the display is also known and can be a liquid crystal display or the like. When the keys are part of a virtual keyboard the display will be composed of touch sensitive material or the like in order to convey information to the controller 207.

The controller 207 includes a processor 211 that is, preferably, a known microprocessor based element that is widely available and can include one or more microprocessors and one or more digital signal processors depending on the precise responsibilities of the controller 207 with respect to signaling duties and call processing that are not here relevant. The processor 211 can be coupled to a port not shown that allows an external device, such as a portable computer or the like to interface to the communications device and thus become, for example, a part of the user interface 2099 or a diagnostic and testing apparatus. In any event the processor 211 is also coupled to a voice recognition unit 213 that performs speech recognition duties and is generally known and available today as a self contained digital signal processor integrated circuit based unit and available in communications devices such as those manufactured by Motorola, Inc of Schaumburg, Ill.

The processor 211 is also coupled to a memory 215 that can be, for example, a combination of known RAM (Random Access Memory), ROM (Read-Only Memory), EEPROM (Electrically Erasable Programmable ROM) or magnetic memory that among other items, such as messages and folders with messages, address books, standard or canned messages, and various operating variables and parameters will store an operating system or software 217 for the processor. This operating software when executed by the processor 211 will result in the processor 211 performing the requisite functions of the communications device such as interfacing with the transceiver or transmitter 205, receiver 203, voice recognition unit 213, and user interface 209 including display and keyboard, audio processing functions and so on including other functional elements not depicted and software routines that will be further described below. The memory 215 further includes call processing routines 219 for supporting voice and data calls that will be appreciated by one of ordinary skill and that will vary depending on air interface, call processing, and service provider specifics.

As depicted, the memory 215 further includes space for one or more service constraints 221 corresponding to one or more specific communications devices or units. The service constraints 221 may include limits on voice or data activities as well as allowed and disallowed targets identified by phone numbers or email addresses as well as predefined sets or packages of limits. Additionally included but not specifically depicted are routine(s) that facilitate service constraint or service request development, preferably, using pull down menus that may be voice driven and selection capabilities interactively with the display and keyboard. For a subordinate communications device, the service constraints can be those that apply or have applied to the subordinate device, and the service request routines would be used.

For a master communications device, or one that controls the services for one or more subordinate devices, the constraints can be those defined for subordinate devices and the routines for developing those service constraints would be used. Master communications devices include an address 223, such as an email address or a telephone number for each subordinate unit or device cross referenced to appropriate service constraints. Subordinate devices include an address or phone number for their master device 225. Additionally subordinate communications devices will include routines for logging activity and for reporting 227 to the master device if desired, preferably, on a periodic basis. The reader or one of ordinary skill will appreciate that this listing is merely a brief listing of exemplary routines that will be required or advantageous in effecting a communications device for controlled services and various command and control duties and that many others 231 including optional applications that can be stored in the memory have not been mentioned.

The following discussion will focus on the operational interactions and refer to the FIG. 2 depiction of a communications device, where this depiction is representative of either a subordinate communication device, master communication device, or both subordinate to another device and also a master to other devices. In the subordinate role the communications device is arranged to provide services for a user where the services that are available for the user or the communications device employed by the user are controlled by at least one other communications device. This subordinate communication device comprises a transceiver, further including the transmitter 205 and receiver 203, where the receiver is arranged and operable to receive from the other communications device, typically via a service provider network 107, an over the air message that includes a service constraint on services available for or available to the communications device. The communications device in the subordinate role further comprises the controller 207, coupled to the transceiver and responsive to the over the air message and inputs from the user, to enable operation of the communications device subject to the service constraint.

The message with the service constraint can be received by the communications device or receiver as a result of the transmitter as controlled by the controller and responsive to the user either directly or indirectly, sending a first message. The first message is, preferably, a data message addressed to the other or master communications device, where the first data message requests services. Thus the over the air message is a second, preferably data, message having the service constraint that has been supplied or forwarded responsive to the first data message that requested the services. The first message sent by the transmitter may comprise a request for either voice services or data services.

For example, the user of the device can attempt to make a phone call or send text message to a friend and the subordinate communications device first checks to see whether this activity is allowed or authorized by the current service constraint that the device is operating accordance with. If allowed the activity or services would be provided. If not allowed the communications device could make an automatic and discreet request for such services at the address for the master communications device and thus the user has indirectly caused a service request message to be forwarded. Alternatively, when a service is not allowed and attempted the subordinate communications device can prompt the user to first obtain permission to use such services. The user would then directly cause a message requesting services to be sent to the master device or unit. If the user realizes that the desired services are not allowed the user can first seek permission via a request message. In any of these cases the subordinate device can prompt the user for a password.

A menu driven approach to formulating a request message, prompted or otherwise, is preferably used. For example, one exemplary approach is selecting the type of services from a pull down menu, including entries such as email, local phone call, long distant phone call, area for telephone number and name to be entered or email address and name (these may be selected from a menu that includes entries from phone books, etc). Then selecting other attributes for the service requested such as origination, reception, or both, and an estimate for amount of services, such as 5 minutes, 10 minutes, etc or 500 characters and so on and possibly a time frame or date range during which permission would be granted can be undertaken.

A master communications device after receiving this request message may be presented with a summary of the requested services including any attributes and be offered a yes, no, or edit decision choice. Again, a menu driven scheme is preferred and if the edit decision is selected the user of the master device can be presented with an opportunity to change any of the requested parameters or to simply select a predefined or predetermined package of constraints, such as 10 minutes of voice time and 1000 characters of text messaging as package 1. There can be any number of predefined packages that can be selected where the master device user, again utilizing a menu driven approach, has predefined these packages. The user of the master device can also adopt policies for dealing with requests, such as automatically granting requests for local calls not exceeding 5 minutes and not exceeding 3 requests per day or up to a 25 minute limit per billing period or the like.

The subordinate communications device or the transmitter as controlled by the controller will also send a reporting message addressed to the other or master communications device. The reporting message, preferably, comprises information corresponding to a portion of the services available that were or have been utilized. This reporting message can include any combination of telephone numbers, email addresses, calling party IDs, time lapsed or number of characters, or equivalents. These messages can be forwarded when prompted by the master device, or sent periodically (daily or hourly) or after each usage or any other prearranged method.

These various request or grant messages, that are sent or that the receiver receives, such as the over the air message can be either a voice message or a data message, with the message including the service constraint corresponding to either allowed services or disallowed services. If the message requesting or granting services is sent via a voice message the message will be routed to the voice recognition unit and converted either before being transmitted or it may be routed and converted, after being received, to data appropriate for use as a service request or service constraint. To facilitate the use of voice messages or data, a menu using the display to prompt for voiced inputs is preferred. Thus when sending or receiving an over the air message comprises sending or receiving a voice message, the speech recognition unit is operable to interpret the voice message to obtain the service request or service constraint.

As noted above the service constraint corresponding to allowed service or disallowed services will often comprise further attributes corresponding to the allowed service or the disallowed service, where the attributes including one or more of a time limitation on service, a quantity of service, such as air time minutes or characters of text, an allowed target (phone number or email address) for service, or a disallowed target for service. The service constraint corresponding to the allowed service or the disallowed service can further comprise a predefined package of one of allowed and disallowed actions or services.

When the communication device of FIG. 2 is a master communications device and therefore arranged to control services available to a user of another communications device, the communications device includes the same or functionally similar elements directed to different purposes. This discussion will be somewhat duplicative and will be presented in summary fashion with much of the detail above understood to be applicable. The receiver 203 is operable to receive an over the air message originated by the other communications device, where the over the air message is requesting services. Further the controller 207 is coupled to the receiver and responsive to the over the air message to then formulate if required and provide a service constraint for services available for the other communications device. The transmitter 205 is coupled to and controlled by the controller 207 and arranged to send a message intended for the other or subordinate communications device, where the message includes the service constraint.

In one embodiment the over the air message can be a first data message and the transmitter is controlled by the controller to send, responsive to the first data message, a second data message addressed to the other communications device, with the second data message including the service constraint. In other embodiments according to the present invention, the over the air message or others may be either a voice message or a data message with the service request, service constraint, or reporting information. As noted above the receiver of the master device can, from time to time, receive a reporting message originated by the other communications device, where the reporting message comprises information corresponding to that portion of the services available or made available by the master to the subordinate that were or have been utilized.

The service constraint provided by the master device will correspond to one or more of allowed services and disallowed services, with each further defined to include attributes such as one or more of a time limitation on service, a quantity of service, an allowed target for service, and a disallowed target for service. The service constraints can be a predefined package or set of allowed or disallowed actions.

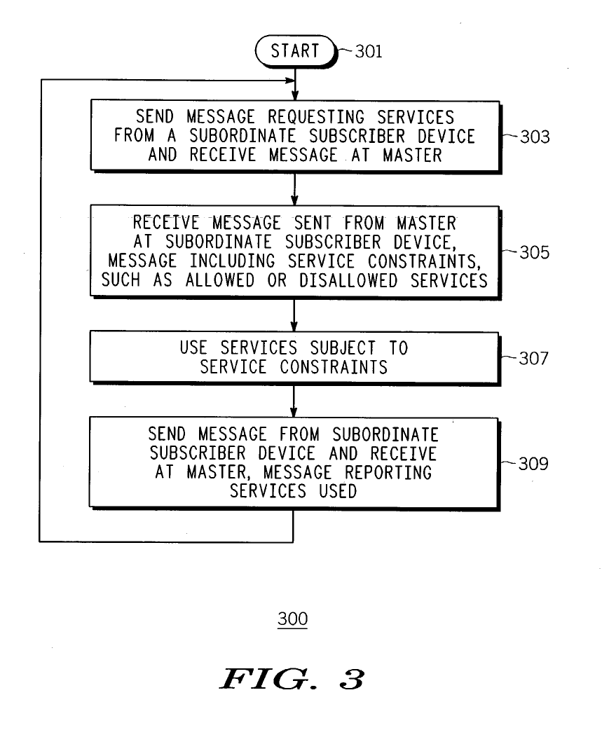

Referring to FIG. 3, a flow chart of a preferred method embodiment of controlling services available to a user of a communications device will be reviewed and discussed. Some of this discussion will be in the nature of a review and summary of portions of the discussions above. The method 300 begins at 301 and is a method of controlling services available to a user of a communications device and is a method suitable for implementation in the communications device of FIG. 2. At 303 the method depicts sending from a communications device that is subordinate a request message intended for the communications device that is the master, the request message requesting services at the subordinate communications device. Then, 305 indicates receiving from the master communications device a message, such as an over the air message, at the subordinate communications device, where the over the air message includes a service constraint on services available for the subordinate communications device. Typically this over the air message with the service constraint is responsive to the request message at 303. At 307 the subordinate communications device is enabled, responsive to the over the air message, to operate and use or utilize services according to and subject to the service constraint. These messages can be either voice messages or data messages and the requested or allowed services may be either voice services or data services.

Periodically or as prompted or after utilizing services, at the subordinate communications device, a portion of the services available, according to the service constraint, 309 shows sending from the communications device a message intended for and received by the master communications device, where the message comprises information corresponding to the portion of the services available that were utilized by the subordinate device.

The message at 305 can be a voice message or a data message that includes the service constraint corresponding to allowed services or disallowed services and can further define various attributes corresponding to the allowed services or the disallowed services, where the attributes including one or more of a time limitation on service, a quantity of service, an allowed target for service, or a disallowed target for service. As noted above the allowed service or the disallowed service can be reflected in a predefined package of one of allowed and disallowed actions or services. It will be appreciated that the described processes and operations can occur among one subordinate device and one master device, one subordinate device and a plurality of master devices, a plurality of subordinate devices and one master device, or any other combination. Furthermore, the service constraint can be distinct and specific to one subordinate communication device and thus a second subordinate communication device would have a second service constraint that can be different from the service constraint for the first such device.

One brief example will serve to demonstrate some of the methodology and operations noted above. The subordinate communications device will be programmed with the email address or telephone number of the master device and identified as a subordinate of the master device, such as via the email address or phone number of the subordinate device. The master device will typically create a password and send it to the subordinate device so that requesting services will require use of the password. The subordinate communications device can default to any prearranged setting for services, such as only enabled to call or send messages to the master. Suppose that only voice services have been disabled and the subordinate wants to make a voice call. The subordinate device sends a message to the master communications device requesting approval to call a number such as 345 6789 and the master replies acknowledging the request and adds a further stipulation of 5 minutes maximum call time. The subordinate device receives the master's acknowledgement and perhaps displays OK to call 345-6789 for 5 minutes. The master can further acknowledge with OK to call any number for 10 minutes. In either case once the phone call(s) have been made the subordinate device can send a message to the master outlining the called number and duration.

The apparatus, processes, and almost personalized service constraints discussed above and the inventive principles thereof are intended to and will alleviate problems caused by prior fixed service constraints. Using these principles of interactively establishing and updating a service constraint and providing services at subordinate device according to there service constraint will facilitate controlling services in a manner that is effective, efficient and friendly thus contributing to user satisfaction. It is expected that one of ordinary skill given the above described principles, concepts and examples will be able to implement other alternative procedures that are communications device dependent and that will also offer additional quick and efficient interface procedures for developing service constraint. It is anticipated that the claims below cover many such other examples.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of controlling services available to a user of a communication device, the method comprising:
receiving from a first communication device a message at a second communication device, the message including a service constraint on services available for the second communication device; and
enabling, responsive to the message, the second communication device to operate according to the service constraint.

2. The method of claim 1 further comprising, sending from the second communication device a request message intended for the first communication device, the request message requesting services and the message is responsive to the request message.

3. The method of claim 2 wherein the sending the request message comprises sending one of a voice message and a data message.

4. The method of claim 3 wherein the sending the request message comprises sending a message requesting one of voice services and data services.

5. The method of claim 1 further comprising, utilizing, at the second communication device, a portion of the services available according to the service constraint.

6. The method of claim 5 further comprising, sending from the second communication device a message intended for the first communication device, the message comprising information corresponding to the portion of the services available that were utilized.

7. The method of claim 1 wherein the receiving the message further comprises receiving one of a voice message and a data message.

8. The method of claim 7 wherein the receiving the one of a voice message and a data message comprises receiving the service constraint corresponding to one of an allowed service and a disallowed service.

9. The method of claim 8 wherein the receiving the service constraint corresponding to one of the allowed service and the disallowed service further comprises attributes corresponding to the one of the allowed service and the disallowed service, the attributes including one of a time limitation on service, a quantity of service, an allowed target for service, and a disallowed target for service.

10. The method of claim 8 wherein the receiving the service constraint corresponding to the one of the allowed service and the disallowed service further comprises receiving a predefined package of one of allowed and disallowed actions.

11. The method of claim 7 wherein, when the receiving the over the air message comprises receiving a voice message, speech recognition is utilized to interpret the voice message to obtain the service constraint.

12. The method of claim 1 wherein the message comprises an over the air message.

13. The method of claim 1 wherein the second communications device receives the message from the first communications device, the first communications device being one of a plurality of master communication devices for the second communications device.

14. A communication device arranged to provide services for a user, the services controlled by a master communication device, the communication device comprising:
a transceiver, comprising a transmitter and receiver, the receiver arranged to receive from the master communication device a message including a service constraint on services available for the communication device; and
a controller, coupled to the transceiver and responsive to the message and inputs from the user, to enable operation of the communication device subject to the service constraint.

15. The communication device of claim 14 wherein the transmitter is controlled by the controller to send a first data message addressed to the master communication device, the first data message requesting services and wherein the message is a second data message responsive to the first data message.

16. The communication device of claim 15 wherein the transmitter sends the first data message comprising a request for one of voice services and data services.

17. The communication device of claim 14 wherein the transmitter is controlled by the controller to, send a reporting message addressed to the master communication device, the reporting message comprising information corresponding to a portion of the services available that were utilized.

18. The communication device of claim 14 wherein the receiver receives the message that further comprises one of a voice message and a data message, the one of the voice message and the data message including the service constraint corresponding to one of an allowed service and a disallowed service.

19. The communication device of claim 18 wherein the service constraint corresponding to one of the allowed service and the disallowed service further comprises an attribute corresponding to the one of the allowed service and the disallowed service, the attribute including one of a time limitation on service, a quantity of service, an allowed target for service, and a disallowed target for service.

20. The communication device of claim 18 wherein the service constraint corresponding to the one of the allowed service and the disallowed service further comprises a predefined package of one of allowed and disallowed actions.

21. The communication device of claim 18 further including a voice recognition unit wherein, when the receiving the over the air message comprises receiving a voice message, the speech recognition unit is operable to interpret the voice message to obtain the service constraint.

22. The communications device of claim 14 wherein the message is received from the master communications device, the master communication device being one of a plurality of master communication devices that control services for the communication device.

23. A communication device arranged to control services available to a user of at least one subordinate communication device, the communication device comprising:
a receiver operable to receive an over the air message originated by the subordinate communication device, the over the air message requesting services;
a controller coupled to the receiver and responsive to the over the air message to provide a service constraint for services available for the subordinate communication device; and
a transmitter coupled to and controlled by the controller and arranged to send a message intended for the subordinate communication device, the message including the service constraint.

24. The communication device of claim 23 wherein the over the air message is a first data message and the transmitter is controlled by the controller to send, responsive to the first data message, a second data message addressed to the subordinate communication device, the second data message including the service constraint.

25. The communication device of claim 23 wherein the receiver further receives a reporting message originated by the subordinate communication device, the reporting message comprising information corresponding to a portion of the services available that were utilized.

26. The communication device of claim 23 wherein the receiver receives the over the air message that further comprises one of a voice message and a data message, the one of the voice message and the data message requesting services.

27. The communication device of claim 28 wherein the service constraint corresponds to one of an allowed service and a disallowed service, the one of the allowed service and the disallowed service further including one of a time limitation on service, a quantity of service, an allowed target for service, and a disallowed target for service.

28. The communication device of claim 26 wherein the service constraint corresponding to the one of the allowed service and the disallowed service further comprises a predefined package of one of allowed and disallowed actions.

29. The communication device of claim 23 wherein the receiver receives the over the air message from one of a plurality of subordinate communication devices and responsive thereto provides the service constraint to the one of the plurality of subordinate communication devices.

30. The communication device of claim 29 wherein the service constraint for the one of the plurality of subordinate communication devices is distinct from a second service constraint for a second of the plurality of subordinate communication devices.
